(19) United States
(12) Patent Application Publication
(10) Pub. No.: US 2025/0371333 A1
(43) Pub. Date: Dec. 4, 2025

(54) HYBRID SELF-ATTENTION FOR OPTIMIZATION OF DECODER AI MODELS

(71) Applicant: NVIDIA Corporation, Santa Clara, CA (US)

(72) Inventors: Samuel Kriman, Santa Clara, CA (US); Dmitry Rekesh, Pleasanton, CA (US)

(21) Appl. No.: 18/679,881

(22) Filed: May 31, 2024

(51) Int. Cl. G06N 3/08

(52) U.S. Cl. CPC G06N 3/08

(57) ABSTRACT

Disclosed are apparatuses, systems, and techniques deploying hybrid self-attention for efficient artificial intelligence (AI) processing, including using sparse attention to obtain hidden states and using full or intermediate attention to predict new tokens. The techniques include predicting, using a set of N hidden states, a token, an individual hidden state of the set of N hidden states being generated, by an attention-based neural network, using M other previously-predicted tokens, such that M is smaller than N.

### TECHNICAL FIELD

At least one embodiment pertains to improving efficiency and reducing latency of computations associated with artificial intelligence (AI) systems. For example, at least one embodiment pertains to deployment of hybrid self-attention for optimization of computation of outputs of decoder AI models.

### BACKGROUND

Well-trained language models—such as large language models (LLMs), vision language models (VLMs), or multi-modal language models—are capable of supporting conversations in natural language, understanding speaker's intent and emotions, explaining complex topics, generating new texts upon receiving suitable prompts, providing advice regarding topics of interest to a user, processing image, audio, and/or other data types, and/or performing other functions. These models typically undergo self-supervised training on massive amounts of text data and/or other data types, depending on the embodiment, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, the models often undergo instructional (prompt-based) supervised fine-tuning that causes the models to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts.

### BRIEF DESCRIPTION OF DRA WINGS

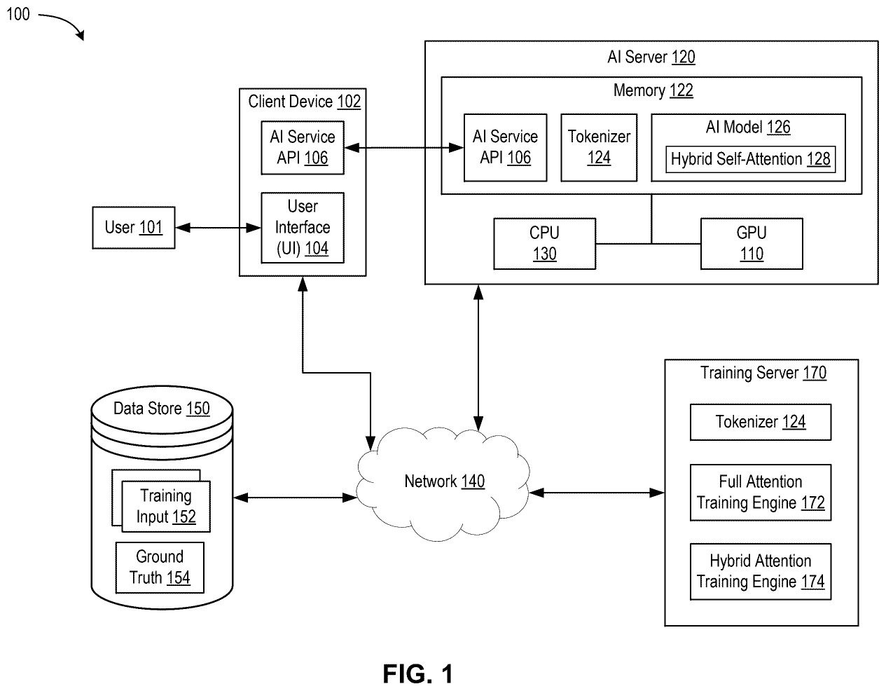

FIG. 1 is a block diagram of an example computer system capable of implementing hybrid self-attention for faster output generation and more efficient AI processing, according to at least one embodiment;

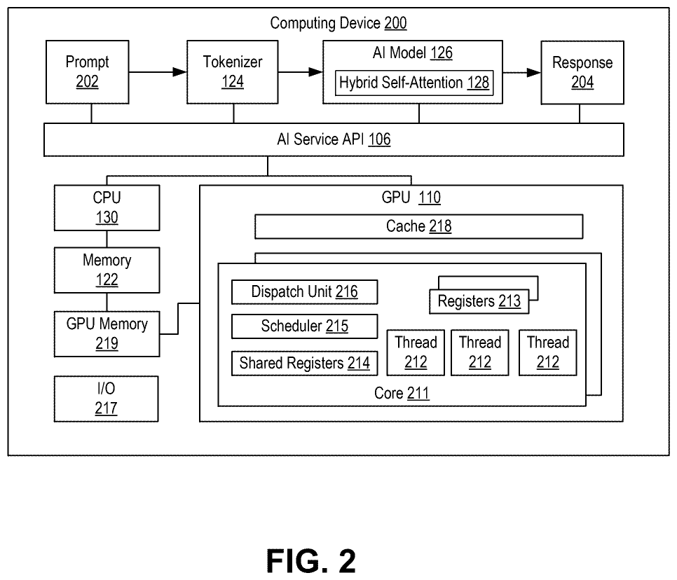

FIG. 2 illustrates an example computing device that supports hybrid self-attention for faster output generation and more efficient AI processing, according to at least one embodiment;

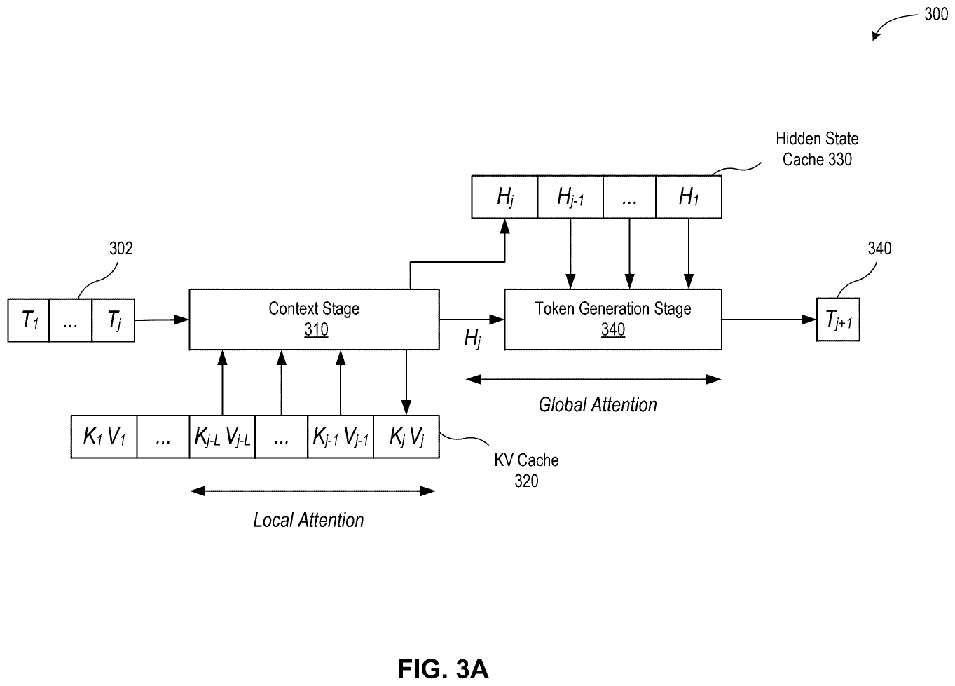

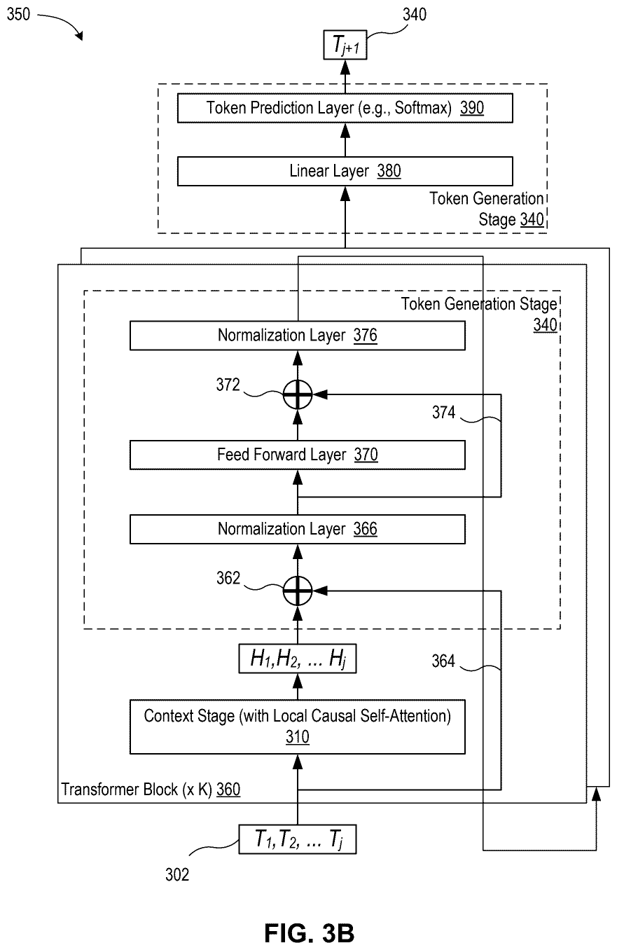

FIG. 3A illustrates an example data flow of operations that deploy hybrid self-attention for fast output generation and efficient AI processing, according to at least one embodiment;

FIG. 3B illustrates an architecture of an example decoder model that implements hybrid self-attention for fast output generation and efficient AI processing, according to at least one embodiment;

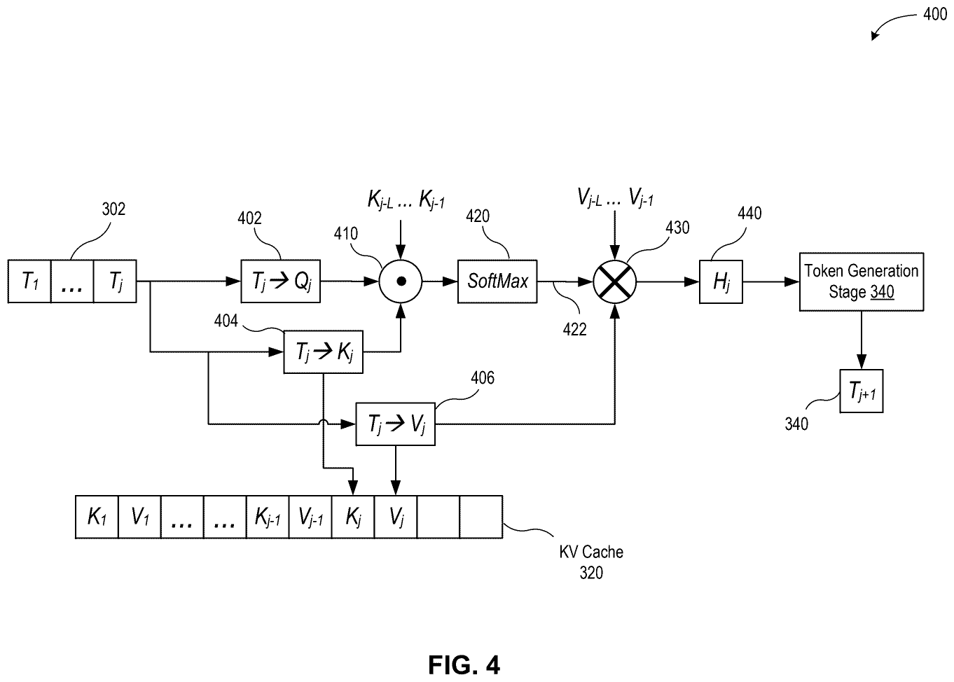

FIG. 4 illustrates example operations of a context stage that deploys sparse self-attention for fast output generation and efficient AI processing, according to at least one embodiment;

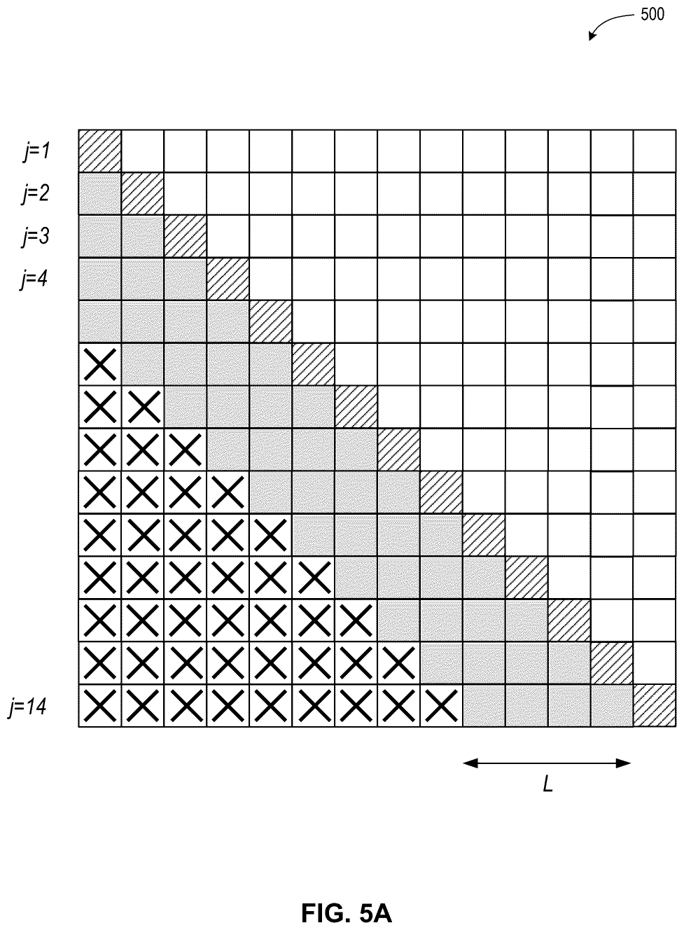

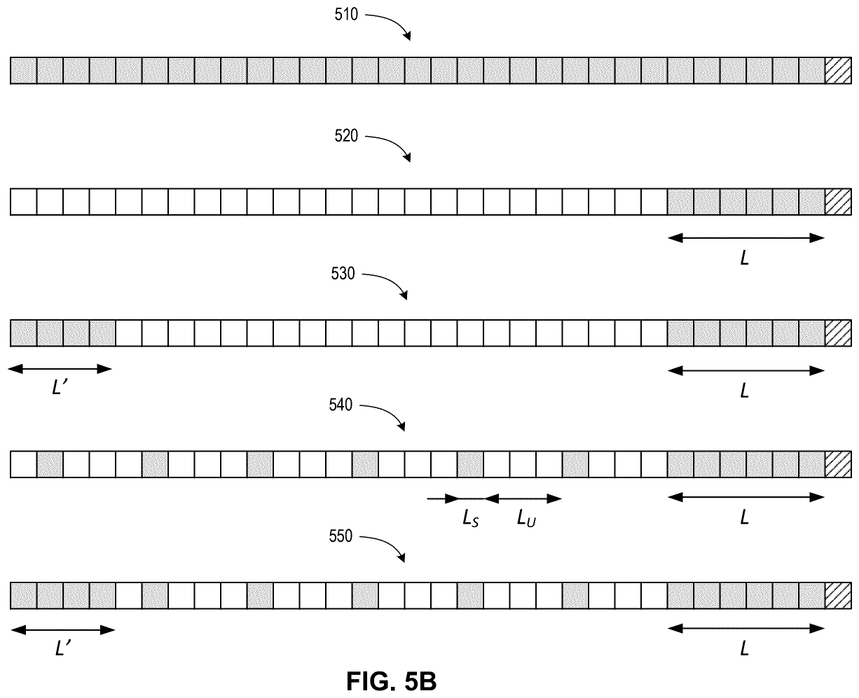

FIG. 5A identifies schematically context stage computations that are performed in the instances of full and sparse self-attention deployed in AI processing, according to at least one embodiment;

FIG. 5B illustrates various self-attention schemes that may be used in the context stage of AI processing, according to at least one embodiment;

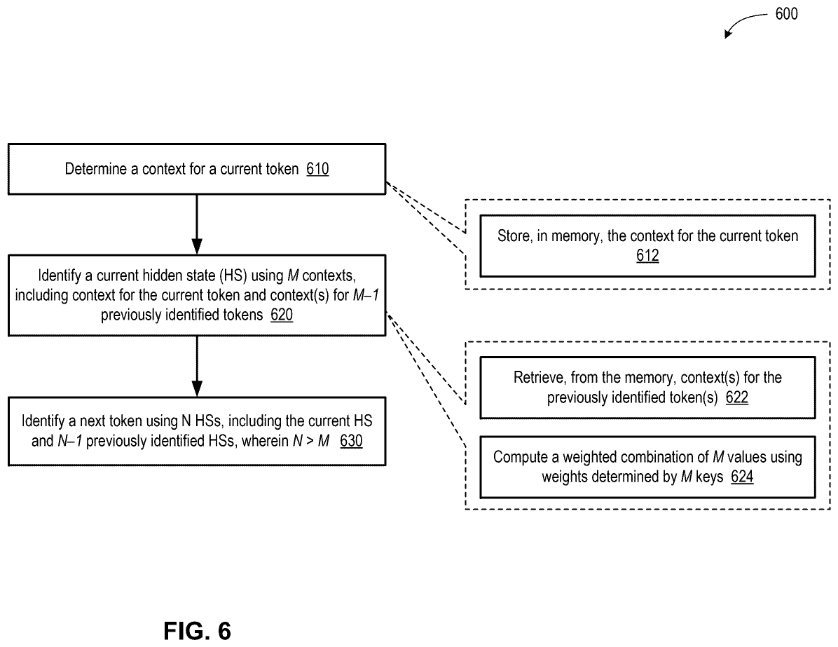

FIG. 6 is a flow diagram of an example method of using hybrid self-attention for fast output generation and efficient AI processing, according to at least one embodiment;

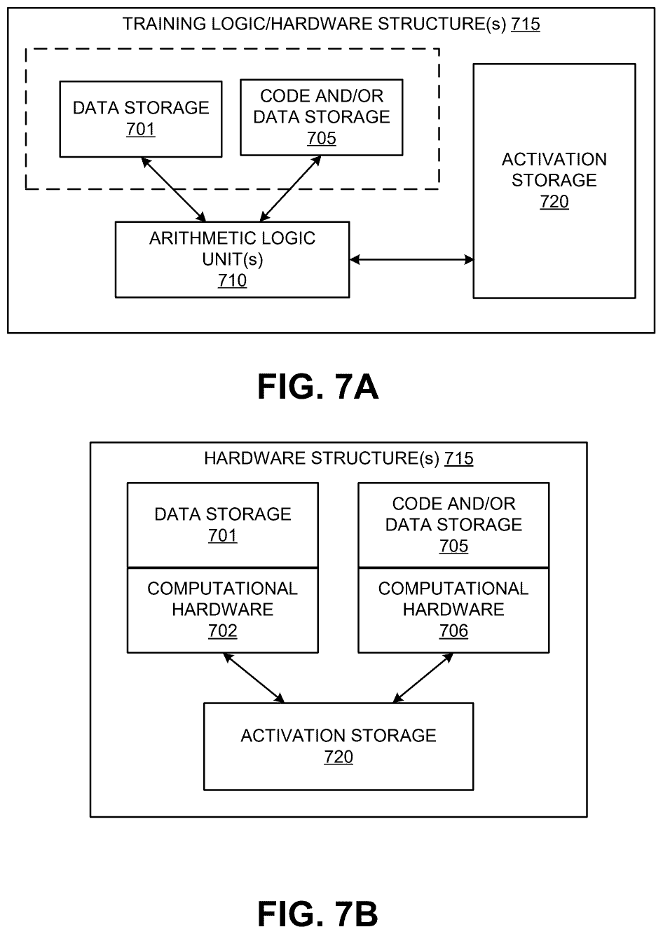

FIG. 7A illustrates inference and/or training logic, according to at least one embodiment;

FIG. 7B illustrates inference and/or training logic, according to at least one embodiment;

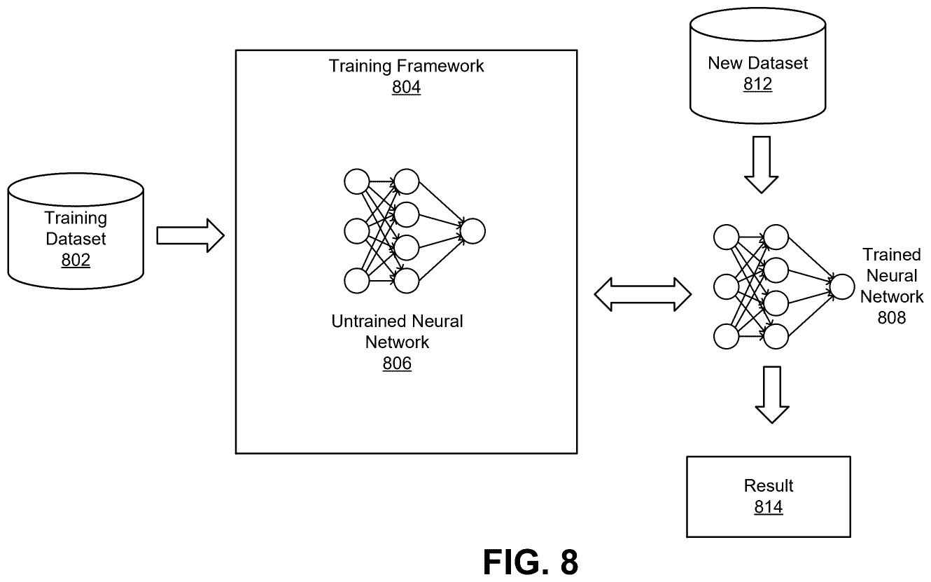

FIG. 8 illustrates training and deployment of a neural network, according to at least one embodiment;

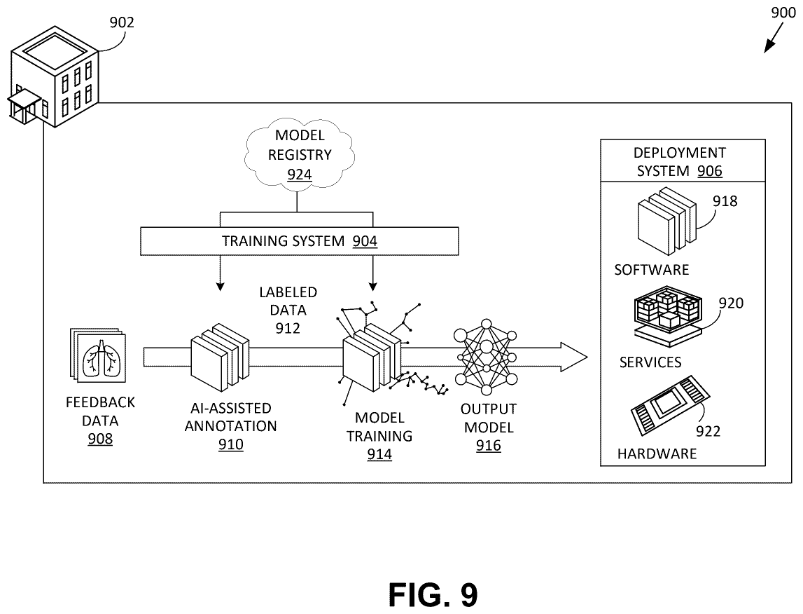

FIG. 9 is an example data flow diagram for an advanced computing pipeline, according to at least one embodiment;

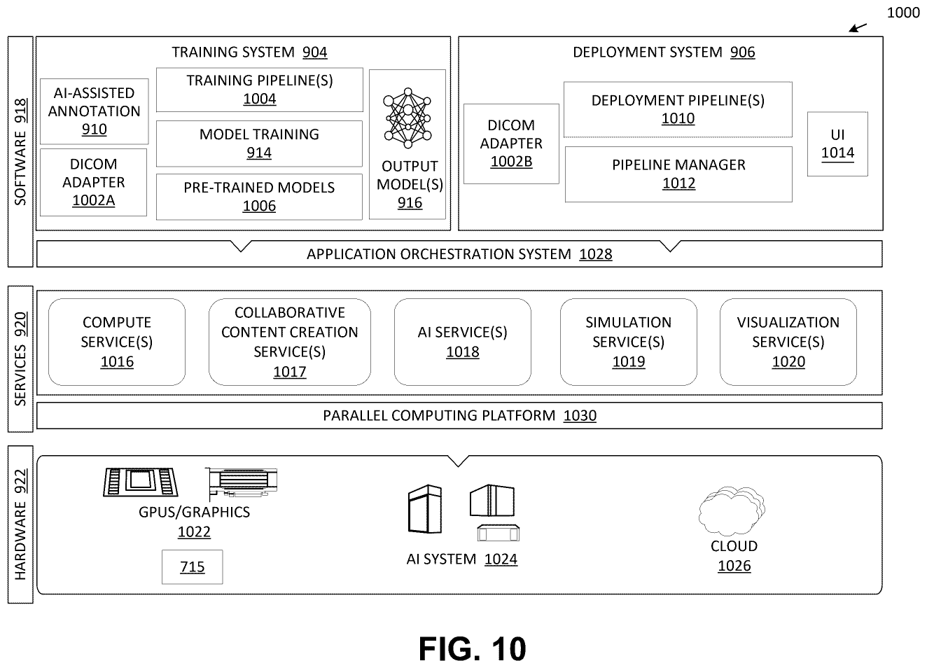

FIG. 10 is a system diagram for an example system for training, adapting, instantiating and deploying machine learning models in an advanced computing pipeline, according to at least one embodiment;

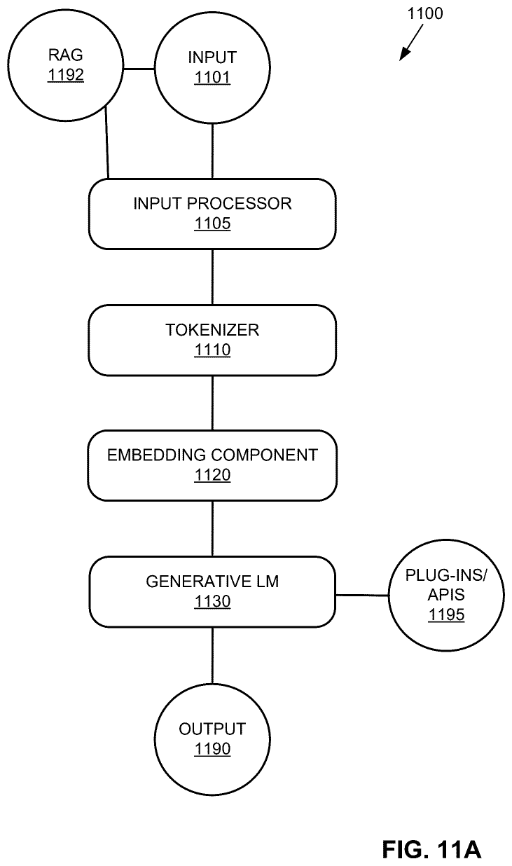

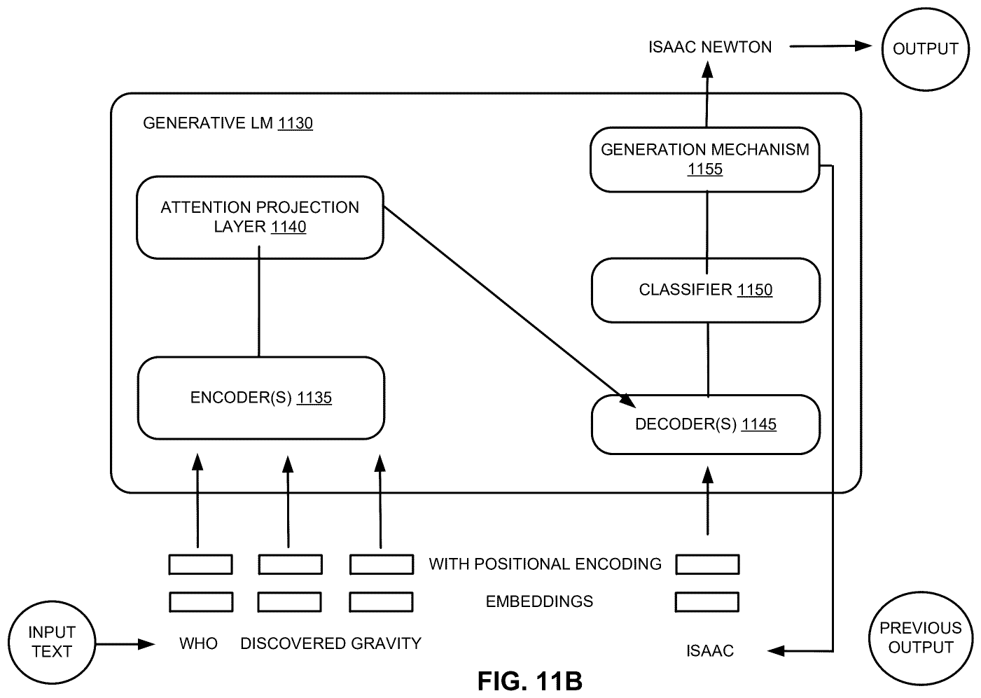

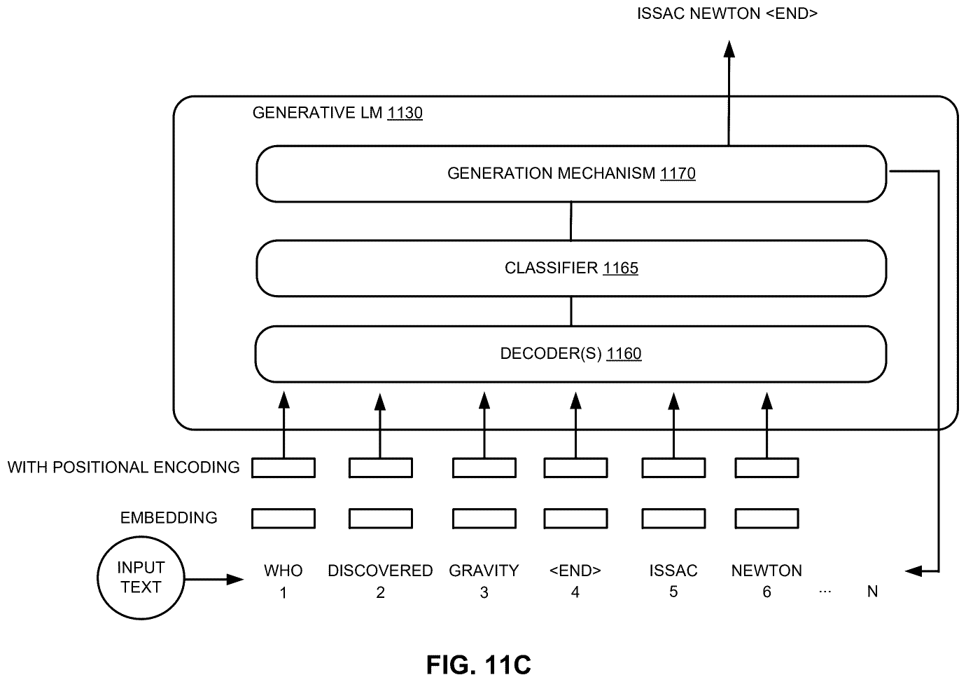

FIG. 11A is a block diagram of an example generative language model system suitable for use in implementing at least some embodiments of the present disclosure;

FIG. 11B is a block diagram of an example implementation in which the generative LM includes a transformer encoder-decoder, according to at least one embodiment; and

FIG. 11C is a block diagram of an example implementation in which the generative LM 1130 includes a decoder-only transformer architecture, according to at least one embodiment.

### DETAILED DESCRIPTION

AI models, including language models (LMs) (e.g., LLMs, VLMs, multi modal language models, etc.), speech processing models (e.g., text-to-speech models, speech-to-text models, translation models, and/or the like), computer vision models, and/or various other AI models often deploy attention-based neural networks. In one example of a generative LM, a model may generate (predict) a next token Tⱼ (which may include one or more words) that follows a sequence T₁ . . . Tⱼ₋₁ of known tokens (e.g., tokens of a prompt) and/or previously generated tokens (e.g., tokens of a response to the prompt). Prediction of token Tⱼ may include a context stage, which determines semantic connections of the previously identified tokens by computing hidden states, and a token generation stage, which uses the computed hidden states to generate the most probable next token. More specifically, the context stage obtains relevance (attention) scores between a token Tⱼ (or a query Qⱼ representing the token) and the previously identified tokens T₁ . . . Tⱼ₋₁ (represented by corresponding keys K₁ . . . Kⱼ₋₁). The set of attention scores is then used to compute a weighted sum of values V₁ . . . , Vⱼ₋₁, Vⱼ for the tokens (including value Vⱼ for the last token Tⱼ) in order to obtain a hidden state Hⱼ for the token Tⱼ. The token generation stage uses the set of hidden states H₁, H₂, . . . Hⱼ generated for the token Tⱼ and various previously identified tokens as an input to generate the next token Tⱼ₊₁. This process is then repeated for further tokens.

The number of computations of each of the context stage and the token generation stage scale as the square of the number of generated tokens N. For a large number N (e.g., thousands and tens of thousands) of tokens, the amount of computation can make real-time token generation (e.g., in live conversations, real-time translations, and/or the like) challenging or impossible.

Aspects and embodiments of the present disclosure address these and other technological challenges of the AI technology by providing for systems and techniques that deploy hybrid self-attention for faster token generation and more efficient AI processing. Hybrid attention combines the use of a sparse attention—limited to a subset of previously identified tokens—in the context stage with a full self-attention in the token generation stage. In some embodiments, during the context stage, the model may compute relevance scores between a token Tⱼ (or query Qⱼ representing the token) and a local subset of L previously identified tokens T_{j-L} . . . Tⱼ₋₁ (represented by the corresponding keys K_{j-L} . . . Kⱼ₋₁). The hidden output Hⱼ for the token Tⱼ may then be computed using a weighted sum of the values V_{j-L} . . . Vⱼ for the L+1 tokens rather than for all j tokens that have been identified so far. As a result, for most tokens, where j>L+1, the number of computations is reduced significantly and the total amount of computations scales proportionally to N rather than to N². More specifically, the number of attention scores computed for the hybrid attention scales as NL rather than N² for the full self-attention. At each jth context stage identifying hidden state Hⱼ (to be used in generating token Tⱼ₊₁), the key Kⱼ and the value Vⱼ for the last predicted token Tⱼ are computed and stored in cache (or some other memory device) together with keys and values stored during previous context stages. The stored keys K₁ . . . Kⱼ and values V₁ . . . Vⱼ are then used in subsequent context stages performed for later-identified tokens. The respective token generation stage uses the set of hidden states Hⱼ₊₁, Hⱼ₊₂ . . . for prediction of tokens Tⱼ₊₂, Tⱼ₊₃, . . . . The token generation stage may use a full self-attention where token Tₘ₊₁ is generated using all previously identified (known and predicted) hidden states H₁, H₂ . . . Hₘ. In some embodiments, the token generation stage may use less than the full self-attention, e.g., a number N′ that is smaller than the total number of generated tokens, L≤N′<N, referred to as intermediate self-attention herein.

The advantages of the disclosed embodiments of deploying a sparse attention for the context stage and a full self-attention (or intermediate self-attention) for the token generation stage include (but are not limited to) a significant reduction in the number of computational operations and the latency of AI output generation. The optimization of the AI processing is progressively more advantageous for larger outputs. The hybrid combination of the sparse attention in context computation and the full (or intermediate) self-attention in token generation captures and uses the most important semantic connections and results in fast processing without a noticeable loss in the quality of the outputs.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), in-vehicle infotainment systems, systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing generative AI operations, systems for performing conversational AI operations, systems for performing light transport simulation, systems for performing collaborative content creation for 3D assets, systems implementing one or more language models, such as large language models (LLMs), vision language models (VLMs), and/or multi modal language models (which may process text, voice, image, and/or other data types to generate outputs in one or more formats), systems implemented at least partially using cloud computing resources, and/or other types of systems.

### System Architecture

FIG. 1 is a block diagram of an example computer system 100 capable of implementing hybrid self-attention for faster output generation and more efficient AI processing, according to at least one embodiment. As depicted in FIG. 1, computer architecture 100 may include an AI server 120, a data store 150, and a training server 170 connected via a network 140. Network 140 may be a public network (e.g., the Internet), a private network (e.g., a local area network (LAN), or wide area network (WAN)), a wireless network, a personal area network (PAN), a combination thereof, and/or another network type.

AI server 120 may include one or more computing devices accessible to a user 101 and providing functionality of an AI model 126 (or multiple AI models 126) supported by AI server 120. In one example non-limiting embodiment, AI model 126 may be or include a language model (LM), but it should be understood that services associated with various other AI models, including but not limited to generative models, may similarly be improved with the disclosed techniques. In particular, AI model(s) 126 may include an automatic speech generation (text-to-speech) model, image generation model, and/or any the like. In some embodiments, computer system 100 may include a client device 102, which may be (or include) one or more computing devices that are under control of user 101, e.g., a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. User 101 may be a person (e.g., an individual user) or an organization (e.g., a collective user). Client device 102 may include a memory and one or more processors (not shown in FIG. 1 for brevity) communicatively coupled to the memory to support local computations performed on client device 102.

In some embodiments, client device 102 may include a user interface (UI) 104 to receive prompts from user 101 and return to user 101 responses to the prompts. UI 104 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, UI 104 may include an audio device, e.g., a combination of a microphone and a speaker, a video device, such as a digital camera to capture an image or a sequence of two or more images (video frames). In some embodiments, text, speech, and/or video input devices may be integrated together (e.g., as part of a smartphone, tablet computer, desktop computer, and/or the like).

Client device 102 may implement access of user 101 to AI server 120 that performs cloud-based prompt processing, storage of data (prompts and/or responses), authentication of data, and/or any other services, e.g., provided to user 101 as part of a paid or free subscription. Processing and storage of data on AI server 120 may be protected using any suitable cryptographic protection techniques, including but not limited to symmetric and asymmetric key cryptography, digital authentication, and/or the like.

AI server 120 may deploy one or multiple computing device that include a memory 122 (e.g., one or more memory devices or units) communicatively coupled to one or more processing devices, such as one or more graphics processing units (GPU) 110, one or more central processing units (CPU) 130, one or more data processing units (DPU), one or more parallel processing units (PPUs), and/or other processing devices (e.g., field-programmable gate arrays (FPGAs), application-specific integrated circuits (ASICs), and/or the like). Memory 122 may include a read-only memory (ROM), a flash memory, a dynamic random-access memory (DRAM), such as synchronous DRAM (SDRAM), a static memory, such as static random-access memory (SRAM), and/or some other memory capable of storing digital data.

In some embodiments, AI server 120 may include one or more AI service API 106. In some embodiments, an API package with AI service API 106 may be downloaded to client device 102. The downloaded API package may be used to install AI service API 106, which provides a set of high-level commands that can be used by user 101 to prepare prompts for AI model 126 and to read responses to the prompts generated by AI model 126.

In some embodiments, AI model 126 may be a large LM (LLM), a VLM, a multi modal LM, etc., e.g., a model with at least 100K of learnable parameters. In such embodiments where AI model 126 includes an LM, user 101 may generate a prompt, which may include a question, request for information, advice, explanation of various general and specialized subject, and/or the like. AI service API 106 may generate one or more calls to communicate the prompt to AI server 120 and have the prompt tokenized by a suitable tokenizer 124 that transforms the prompt into tokens recognizable by AI model 126. A set of tokens may be specific to AI model 126 (e.g., may be different for different models and/or model creators) and fixed at training of AI model 126. The set of tokens may include any suitable representation of units of speech (e.g., syllables, words, etc.) as numbers. In one example of GPT-4 tokens, word “the” may be represented via token “280”, word “import” may be represented via token “476,” word “description” may be represented via token “4097,” and so on. In some embodiments, individual words may be represented via any number of tokens or word transitions. For example, a long word or a word that contains multiple words may be represented via multiple tokens, e.g., with one token used to represent a beginning portion of the word and another token(s) representing a middle or end portion of the word. In some instances, even a long/composite word may be represented by a single token. As such, the tokenization may be performed in any manner that is suitable for inputs into AI model 126.

Tokenized prompt may be processed by AI model 126 that generates a response, e.g., an answer to the user's question, an explanation of a topic, an essay, a legal document, a poem, and/or any other suitable generated output. AI service API 106 may communicate the response to user 101, e.g., by displaying the response on a screen device of UI 104, by generating a sound using a speaker device of UI 104, and/or by communicating the response to user 101 in any suitable way that user 101 can consume. In some embodiments, AI model 126 may be a decoder model, e.g., a decoder-only model, that receives a set of embeddings representing a tokenized prompt via any number of prompt tokens T₁ . . . Tₚ and processes the prompt tokens using attention blocks of AI model 126 to identify contextual connections between various prompt tokens. AI model 126 may then generate new tokens, e.g., tokens of response, Tₚ₊₁, Tₚ₊₂ . . . . In some embodiments, the tokens of response may be generated sequentially—autoregressively—with tokens of the prompt T₁ . . . Tₚ and the corresponding contexts used to generate a first token of the response Tₚ₊₁. AI model 126 may then compute self-attention scores (also referred to as attention scores, for brevity) characterizing contextual connections of the new token Tₚ₊₁ with various previous tokens (tokens of the prompt) and use these attention scores to generate the next token Tₚ₊₂ of the response, and so on. Following completion of the response (e.g., indicated by an end-of-string or EoS symbol) and providing the response to user 101, a new prompt from user 101 may be received, and the process may continue with generating an additional response, with the attention scores computed between various tokens of the new prompt (and the additional response) and tokens of the original prompt (and the response), and so on.

In some embodiments, AI model 126 may deploy a hybrid self-attention 128, as disclosed herein. Hybrid self-attention 128 may limit the number of previous tokens to which a given token Tⱼ is compared (“attends to”) during the context-generation stage (referred to as sparse attention herein), but need not limit the number of hidden state outputs—computed for various tokens—that are used to generate new tokens (full self-attention) or limit the number of hidden state outputs to a number that is between the number of computed self-attention scores and the total number of generated (and/or received with the prompt) tokens (intermediate self-attention).

In some embodiments, AI model 126 may be trained by training server 170. In those embodiments where AI model 126 includes an LM, the LM may be trained in multiple stages. Initially, training server 170 may train the LM to capture syntax and semantics of human language, e.g., by training to predict a next, a previous, and/or a missing word in a sequence of words (e.g., one or more sentences of a human speech or text). The LM may be further trained using training data containing a large number of texts, such as human dialogues, newspaper texts, magazine texts, book texts, web-based texts, and/or any other texts. Since ground truth for such training is embedded in the texts themselves, training server 170 may use such texts for self-supervised training of the LM. This teaches the LM how to carry out a conversation with a user (a human user or another computer) in a natural language in a manner that closely resembles a dialogue with a human speaker, including understanding the user's intent and responding in ways that the user expects from a conversational partner. Following the initial self-supervised training, training server 170 may implement a supervised fine-tuning of the LM to teach the LM more specialized language skills, including expertise in a particular field of knowledge.

The LM and/or other AI models 126 may be implemented using neural networks with a large number (e.g., billions) of artificial neurons. In at least one embodiment, AI models 126 may be implemented as deep learning neural networks having multiple levels of linear and non-linear operations. For example, AI models 126 may include convolutional neural networks, recurrent neural networks, fully-connected neural networks, long short-term memory (LSTM) neural networks, neural networks with attention, e.g., transformer neural networks, a combination of a convolutional network and one or more transformers (a conformer), and/or neural networks of other types. In at least one embodiment, AI models 126 may include multiple neurons, with an individual neuron receiving its input from other neurons and/or from an external source and producing an output by applying an activation function to the sum of weighted (using trainable weights) inputs and, possibly, a bias value. In at least one embodiment, AI models 126 may include multiple neurons arranged in layers, including an input layer, one or more hidden layers, and/or an output layer. Neurons from adjacent layers may be connected by weighted edges.

Initially, parameters (e.g., edge weights and biases) of AI models 126 may be assigned some starting (e.g., random) values. For various training inputs 152, e.g., documents, images, speech utterances, and/or the like (depending on a type of AI model 126), training server 170 may cause AI model 126 to generate training output(s). Training server 170 may include one or more training engines, e.g., a full attention training engine 172, a hybrid attention training engine 174, and/or other similar training engine. Full attention training engine 172 may train the AI model 126 to use full (or intermediate) self-attention in both the context stage and the output (e.g., token) generation stage, e.g., with newly generated tokens attending to all previously generated (or prompt) tokens. Hybrid attention training engine 174 may train the AI model 126 to use sparse self-attention in the context stage, e.g., with newly generated tokens attending to a limited number of previously generated (or prompt) tokens, and use the full (or intermediate) self-attention in the output generation stage. In some embodiments, AI model 126 may be trained using full attention training engine 172 and then deployed with hybrid self-attention 128 for inference of new inputs. In some embodiments, AI model 126 may be trained using hybrid attention training engine 174 and deployed with hybrid self-attention 128 for inference of new inputs. In some embodiments, AI model 126 may be trained using both full attention training engine 172 for some training epochs and hybrid attention training engine 174 for other training epochs.

During training, a training engine (e.g., full attention training engine 172, hybrid attention training engine 174, and/or the like) deployed by training server 170 may process training input(s), e.g., training prompt(s) tokenized using tokenizer 124, generate a training output using AI model 126 and compare training output(s) with the desired target output. The resulting error or mismatch, e.g., the difference between the target output(s) and the training output(s), may be backpropagated through various neural layers of AI model 126, and the weights and biases of AI model 126 may be adjusted to make the training outputs closer to the target outputs. In some embodiments, training server 170 may train multiple AI models 126 or multiple tasks, e.g., multiple different fields of knowledge.

Training server 170 may be implemented on a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any suitable computing device capable of performing the techniques described herein. Training server 170 may include or communicate with one or more memory devices or units (not shown in FIG. 1), e.g., ROM, flash memory, DRAM, SDRAM, SRAM, and/or some other memory capable of storing digital data. The one or more memory devise may be communicatively coupled to one or more processing devices, such as one or more GPUs, CPUs, DPUs, PPUs, FPGAs, ASICs, and/or other processing devices.

In some embodiments, training server 170 may facilitate any, some, or all stages of training of AI model 126. For example, training server 170 may oversee a self-supervised training stage, focused on development of general language proficiency, and then pass pretrained AI model 126 to another entity for additional fine-tuning of AI model 126. In some instances, training server 170 may receive pretrained AI model 126 from another entity (server) and perform fine-tuning of AI model 126. In some instances, training server 170 may perform both pretraining of AI model 126 and field-specific fine-tuning of AI model 126.

In some embodiments, training inputs 152 and ground truth 154 may be stored in data store 150 accessible to training server 170 via a bus, interconnect, and/or the like, or (as shown in FIG. 1) via network 140. Data store 150 may include a persistent storage and may be hosted by one or more storage devices, such as main memory, magnetic or optical storage disks, tapes, or hard drives, network-attached storage (NAS), storage area network (SAN), and so forth. Although depicted as separate from AI server 120 and/or training server 170, in at least some embodiments, data store 150 may be a part of AI server 120 and/or training server 170. In at least some embodiments, data store 150 may be a network-attached file server, while in other embodiments data store 150 may be some other type of persistent storage, such as an object-oriented database, a relational database, and so forth, that may be hosted by AI server 120 and/or training server 170 or one or more different machines coupled to AI server 120 and/or training server 170.

FIG. 2 illustrates an example computing device 200 that supports hybrid self-attention for faster output generation and more efficient AI processing, according to at least one embodiment. In at least one embodiment, computing device 200 may be a part of AI server 120, and/or a part of client device 102. In at least one embodiment, AI service APIs 106 may operate on computing device 200. AI service APIs 106 may facilitate processing of a prompt 202, e.g., by operating tokenizer 124, and AI model 126 with hybrid self-attention 128, and/or other components not explicitly depicted in FIG. 2, to generate a response 204 to prompt 202.

Operations and calls of AI service APIs 106 and various modules operating in conjunction with AI service APIs 106, and/or other software/firmware operating on computing device 200 may be executed using one or more GPUs 110, one or more CPUs 130, one or more parallel processing units (PPUs) or accelerators, such as a deep learning accelerator, data processing units (DPUs), and/or the like. In at least one embodiment, a GPU 110 includes multiple cores 211, each core being capable of executing multiple threads 212. Each core may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, each core 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 110 may have a (high-speed) cache 218, access to which may be shared by multiple cores 211. Furthermore, computing device 200 may include a GPU memory 219 where GPU 110 may store intermediate and/or final results (outputs) of various computations performed by GPU 110. After completion of a particular task, GPU 110 (or CPU 130) may move the output to (main) memory 122. In at least one embodiment, CPU 130 may execute processes that involve serial computational tasks whereas GPU 110 may execute tasks (such as multiplication of inputs of a neural node by weights and adding biases) that are amenable to parallel processing.

FIG. 3A illustrates an example data flow 300 of operations that deploy hybrid self-attention for fast output generation and efficient AI processing, according to at least one embodiment. During an inference stage, data flow 300 may correspond to operation of AI model 126 illustrated in FIG. 1 and FIG. 2. During a training stage, data flow 300 may be facilitated by hybrid attention training engine 174 that trains AI model 126. During the training stage, operations illustrated in FIG. 3A may be performed as part of an initial training (pretraining) of AI model 126, including but not limited to predicting a next token in a sentence (or some other sequence of words) encountered in any suitable corpus of texts. In some embodiments, operations illustrated in FIG. 3 may be performed as part of a fine-tuning of AI model 126, including but not limited to training AI model 126 to perform specialized language tasks (e.g. drafting particular documents), learn specific fields of knowledge, and or the like. In some embodiments, operations illustrated in FIG. 3 may be performed as part of both the initial training and fine-tuning AI model 126. Training performed in association with data flow 300 may include supervised training, self-supervised training, reinforcement training, unsupervised training, or any combination thereof.

Data flow 300 illustrates operations of a single iteration performed to generate a new token Tⱼ₊₁ 340 that follows an ordered set of previously identified tokens T₁ . . . Tⱼ 302. The set of tokens 302 may include known tokens, e.g., tokens of a prompt, and/or previously generated (predicted) tokens of a response to the prompt, and/or the like. Prediction of token Tⱼ₊₁ 340 may include a context stage 310, which determines semantic connections of the previously identified (known and/or predicted) tokens, and a token generation stage 340, which uses the semantic connections to generate the most probable next token. Context stage 310 evaluates attention scores between the most recently generated token Tⱼ and a limited number L of earlier identified tokens T_{j-L} . . . Tⱼ₋₁ represented by corresponding keys K_{j-L} . . . Kⱼ₋₁, which were computed during the previous iterations and stored in key-value (KV) cache 320. Since the model also computes attention score of the latest token Tⱼ with itself, the key Kⱼ for the latest token may likewise be computed during this iteration and stored in KV cache 320. The set of attention scores is then used to compute a weighted sum of values V_{j-L} . . . , Vⱼ₋₁, Vⱼ for the tokens (including value Vⱼ for the last token Tⱼ) retrieved from KV cache 320 (values V_{j-L} . . . , Vⱼ₋₁ computed during earlier iterations) or computed during this iteration (value Vⱼ). The computed value Vⱼ may also be stored in KV cache 320 for future use.

A hidden state Hⱼ for the token Tⱼ may be computed as the weighted sum of the values V_{j-L} . . . Vⱼ. Token generation stage 340 may then use this computed hidden state Hⱼ together with the set of hidden states H₁, H₂, . . . Hⱼ₋₁ generated for the previous tokens and stored in hidden state (HS) cache 330 as an input to generate the next token Tⱼ₊₁ 340. Although not explicitly depicted in FIG. 3, token generation stage 340 may also use other inputs, e.g., tokens T₁ . . . Tⱼ 302. For example, token generation sage 340 may process sums of tokens and the respective hidden states, T₁+H₁, T₂+H₂, . . . Tⱼ+Hⱼ, as disclosed below in conjunction with FIG. 3B. In some embodiments, an AI model may have multiple context stages 310 and token generation stages 340 performed one after another. In such instances, data flow 300 may be repeated multiple times, as illustrated below in conjunction with FIG. 3B.

FIG. 3B illustrates an architecture of an example decoder model 350 that implements hybrid self-attention for fast output generation and efficient AI processing, according to at least one embodiment. In one embodiment, example decoder model 350 may be a transformer-type model with multiple (e.g., n) transformer blocks 360. As disclosed in conjunction with FIG. 3A, individual transformer blocks 360 may perform operations of context stage 310 that use local causal self-attention to identify hidden states Hⱼ₊₁ based on L previous tokens: Hⱼ₊₁=H (T_{j-L} . . . Tⱼ₋₁). Transformer blocks 360 may further perform one or more operations of token generation stage 340 that uses full (or intermediate) attention. More specifically all hidden states generated during the first j iterations, H₁, H₂, . . . Hⱼ, may be used as an input into prediction of the next token Tⱼ₊₁. As illustrated, addition 362 may add tokens T₁, T₂, . . . Tⱼ, provided via a skipped connection 364, to the respective hidden states: T₁+H₁, T₂+H₂, . . . Tⱼ+Hⱼ. The result may be processed by a normalization layer 366 and a feed-forward layer 370. The output of feed-forward layer 370 may be added (addition 372) to the input into feed-forward layer 370 using another skipped connection 374 and processed by another normalization layer 376. The output of the transformer block 360 may be used as an input into the next transformer block, and so on. The output of the final transformer block may be processed by a linear layer 380 and a token prediction layer 390, which may be a SoftMax layer assigning probabilities to various tokens of a corpus of tokens (corresponding to a known dictionary of words) and the token with the highest probability may be selected as the next token Tⱼ₊₁.

FIG. 4 illustrates example operations 400 of a context stage that deploys sparse self-attention for fast output generation and efficient AI processing, according to at least one embodiment. Context stage illustrated in FIG. 4 may be context stage 310 of FIG. 3A. Operations 400 may include computing query Qⱼ, key Kⱼ, and value Vⱼ for the most recently predicted token Tⱼ of the tokens T₁ . . . Tⱼ 302. For example, query Qⱼ may be obtained by multiplying token Tⱼ (or an embedding representing token Tⱼ) by a learned query-generating matrix M^{Q} (block 402),

$${Q}_{j} = {M}^{Q} {T}_{j} .$$

Similarly, token Tⱼ may be multiplied by a learned key-generating matrix Kⱼ (block 404) to obtain key Kⱼ,

$${K}_{j} = {M}^{K} {T}_{j} ,$$

and also multiplied by a learned value-generating matrix M^{V} (block 406) to obtain value Vⱼ for a token Tⱼ:

$${V}_{j} = {M}^{V} {T}_{j} .$$

The computed key Kⱼ and value Vⱼ may be stored in KV cache 320, for use in subsequent iterations.

Operations 400 may further include, at multiplication 410, computing scalar products (dot products) of query Qⱼ computed for token Tⱼ with L previously identified keys K_{j-L} . . . Kⱼ₋₁ and the new key Kⱼ:

$${Q}_{j} \cdot {K}_{j - L} ; ... ; {Q}_{j} \cdot {K}_{j - 1} ; {Q}_{j} \cdot {K}_{j} .$$

The computed scalar products may then be used as an input into a SoftMax function 420 to generate weights W_{j-L} . . . Wⱼ 422. The weights 422 may be used to multiply, at multiplication 430, L+1 values V_{j-L} . . . Vⱼ to generate hidden state Hⱼ 440 for token Tⱼ:

$${H}_{j} = {\sum }_{i = j - L}^{j} {W}_{i} \times {V}_{i} .$$

The hidden state Hⱼ 440 may be used as an input into token generation stage 340 (e.g., as disclosed in conjunction with FIG. 3A) to generate the next token Tⱼ₊₁ 340.

FIG. 5A identifies schematically context stage computations that are performed in the instances of full and sparse self-attention deployed in AI processing, according to at least one embodiment. FIG. 5A shows a table 500 illustrating multiple iterations j=1 . . . 14 that autoregressively identify respective tokens Tⱼ₊₁. Tokens T that serve as queries Qⱼ during the corresponding iteration j are illustrated with cross-hatched cells of the table. In full causal self-attention, query Qⱼ attends to various past tokens Tₖ with k<j, and to the current (most recently predicted) token Tⱼ and does not attend to future tokens Tₖ with k>j, as future tokens may not have been predicted yet (in the instances of response tokens) or masked (in the instance of prompt tokens). The unattended tokens are indicated with white cells. The tokens attended in full self-attention are all tokens marked with cross-hatching, shading, and crosses. In sparse causal attention, query Qⱼ attends to various past and current tokens Tₖ provided that j−L≤k≤j, where L is the size of the sliding window. The tokens that are attended to in full self-attention but are not attended to in sparse (sliding-window) self-attention are indicated with crosses.

FIG. 5B illustrates various self-attention schemes that may be used in the context stage of AI processing, according to at least one embodiment. Lines of tokens in FIG. 5B correspond to rows of the table of tokens of FIG. 5A. Only causally connected tokens k≤j are shown. Tokens serving as queries are indicated with the cross-hatched cells. Tokens that are attended to are indicated with shaded cells while unattended tokens are indicated with white cells. Self-attention scheme 510 corresponds to the full attention. Self-attention scheme 520 corresponds to the sparse self-attention with a sliding window of L tokens. Self-attention scheme 530 corresponds to the sparse self-attention augmented with a fixed window of L′ tokens at the start of the token sequence. Self-attention scheme 540 corresponds to the sparse self-attention augmented with regularly (at fixed intervals) sampled tokens throughout the length of the token sequence. In various embodiments, any number L_{S} of contiguously sampled tokens may be interspersed by any number L_{U} of unsampled tokens (an illustrative non-limiting example of L_{S}=1 and L_{U}=3 is shown in self-attention scheme 540). Self-attention scheme 550 corresponds to the sparse self-attention augmented with regularly sampled tokens and additional tokens at the start of the token sequence. In some embodiments, a sliding window of fixed size L may be augmented with a predetermined number of randomly sampled tokens. In some embodiments, a sliding window itself may have a random size. In some embodiments, the number of randomly sampled tokens may also be random.

FIG. 6 is a flow diagram of an example method 600 of using hybrid self-attention for fast output generation and efficient AI processing, according to at least one embodiment. Method 600 may be used in the context of training, validation, and/or inference of any suitable AI model, e.g., a neural network model, that deploys a self-attention mechanism. In at least one embodiment, method 600 may be performed using one or more processing units (e.g., CPUs, GPUs, accelerators, PPUs, DPUs, etc.) of AI server 120 and/or one or more processing units of training server 170 of FIG. 1. The processing units performing method 600 may include (or communicating with) one or more memory devices. In at least one embodiment, processing units performing method 600 may be executing instructions stored on a non-transient computer-readable storage media. In at least one embodiment, method 600 may be performed using multiple processing threads (e.g., CPU threads and/or GPU threads), with individual threads executing one or more individual functions, routines, subroutines, or operations of the methods. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

In some embodiments, method 600 may include performing a plurality of iterations of a neural network decoder. An individual iteration of the plurality of iterations may include a context stage and a token generation stage. As illustrated in FIG. 6, method 600 may include, at block 610, performing the context stage of the individual iteration may include determining a context associated with a current token (e.g., Tⱼ) of a plurality of tokens (e.g., T₁ . . . Tⱼ, with reference to FIG. 3A). Determining the context may include computing a key (e.g., Kⱼ), associated with the current token, a value (e.g., Vⱼ), associated with the current token, and/or the like. In some embodiments, the context may include a query (e.g., Qⱼ) associated with the current token. In some embodiments, e.g., where method 600 is implemented as part of operations of a language model. In other embodiments, method 600 may be implemented as part of operations of a text-to-speech model, speech-to-text model, text-to-text (e.g., translation) model, and/or any other AI model that uses causal self-attention. An individual token of the plurality of tokens may be a language unit associated with a word, a portion of a word, a combination of two or more words, a punctuation mark, an end of string symbol, and/or the like.

In some embodiments, as illustrated with the callout block 612, the context stage of the individual may include storing, in a memory device, the determined context representing the current token of a plurality of tokens (e.g., storing key Kⱼ and value Vⱼ associated with the token Tⱼ).

The context stage may further include identifying, at block 620, using a plurality of M contexts, a current hidden state (e.g., Hⱼ). The plurality of M contexts may include the context associated with the current token and one or more contexts associated with corresponding one or more (e.g., M−1) previously identified tokens of the plurality of tokens.

In some embodiments, identifying the current hidden state may include operations of the bottom callout portion of FIG. 6. For example, at block 622, method 600 may include retrieving, from the memory device, the one or more contexts associated with the one or more previously identified tokens of the plurality of tokens. At block 624, method 600 may include computing a weighted combination of a plurality of M values. An individual context of the plurality of M contexts may include a respective value of the plurality of M values and a respective key of the plurality of M keys. For example, as illustrated in FIG. 3B, the respective value Vᵢ of the plurality of M values may be weighted, in the weighted combination of the plurality of M values, using a weight characterizing a degree of similarity of a respective key Kᵢ of a plurality of M keys to a query Qⱼ associated with the current token Tⱼ.

In some embodiments, individual values Vᵢ of the plurality of M values and individual keys Kᵢ of the plurality of M keys obtained based on the corresponding tokens Tᵢ using one or more parameters learned during training of the neural network decoder (e.g., using the learned matrices M^{V} and M^{K}, as described in conjunction with FIG. 3B).

Performing the token generation stage of the individual iteration of method 600 may include, at block 630, identifying, using a plurality of N hidden states, a next token (e.g., Tⱼ₊₁) of the plurality of tokens. The plurality of N hidden states may include the current hidden state (e.g., Hⱼ), and one or more hidden states (e.g., Hⱼ₋₁, Hⱼ₋₂) identified during corresponding one or more previous iterations of the plurality of iterations. In the embodiments that use sparse self-attention during the context stage and full or intermediate self-attention during the token generation stage, N is greater than M. In some embodiments, M is equal or less than a predetermined number. For example, as illustrated in FIG. 5A, M<4 during the first four iterations of the context stage and M=4 during subsequent iterations of the context stage.

In some embodiments, for an iteration (e.g., j+1th iteration) that is subsequent to the individual iteration (e.g., j+1th iteration) of the plurality of iterations, N is incremented by one, and M remains unchanged (e.g., for j>4 iterations illustrated in FIG. 5A).

In some embodiments, e.g., as illustrated with self-attention scheme 550 FIG. 5B, the plurality of M contexts are associated with (i) a first subset of most recently identified tokens (L most recent tokens), and (ii) a second subset of tokens (e.g., L′ early tokens) separated from the first subset of tokens by one or more tokens that are unrepresented in the plurality of M contexts.

### Inference and Training Logic

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and

corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. patent application Ser. No. 18/304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text cleaning to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc from the input 1101 can be generated. As such, the model(s) may not only rely on its own knowledge from training on a large dataset(s) and/or from data retrieved using the RAG component 1192, but also on the expertise or optimized nature of one or more external resources-such as the plug-ins/APIs 1195.

FIG. 11B is a block diagram of an example implementation in which the generative LM 1130 includes a transformer encoder-decoder, according to at least one embodiment. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture, according to at least one embodiment. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
performing a plurality of iterations of a neural network decoder, wherein an individual iteration of the plurality of iterations comprises a context stage and a token generation stage, wherein performing the context stage of the individual iteration comprises:
determining a context associated with a current token of a plurality of tokens; and
identifying, using a plurality of M contexts, a current hidden state, wherein the plurality of M contexts comprises:
the context associated with the current token, and
one or more contexts associated with corresponding one or more previously identified tokens of the plurality of tokens; and
wherein performing the token generation stage of the individual iteration comprises:
identifying, using a plurality of N hidden states, a next token of the plurality of tokens, wherein the plurality N hidden states comprises:
the current hidden state, and
one or more hidden states identified during corresponding one or more previous iterations of the plurality of iterations, wherein N is greater than M.

2. The method of claim 1, wherein identifying the current hidden state comprises:
computing a weighted combination of a plurality of M values, wherein an individual context of the plurality of M contexts comprises a respective value of the plurality of M values.

3. The method of claim 2, wherein the respective value of the plurality of M values is weighted, in the weighted combination of the plurality of M values, using a weight characterizing a degree of similarity of a respective key of a plurality of M keys to a query associated with the current token, wherein the individual context of the plurality of M contexts further comprises the respective key of the plurality of M keys.

4. The method of claim 3, wherein each of (i) an individual value of the plurality of M values and (i) an individual key of the plurality of M keys is obtained based on a corresponding token of the plurality of tokens using one or more parameters learned during training of the neural network decoder.

5. The method of claim 1, wherein an individual token of the plurality of tokens comprises a language unit associated with at least one of:
a word,
a portion of a word,
a combination of two or more words,
a punctuation mark, or
an end of string symbol.

6. The method of claim 1, wherein performing the context stage of the individual iteration further comprises:
storing, in a memory device, the determined context associated with the current token of a plurality of tokens; and
wherein identifying the current hidden state comprises:
retrieving, from the memory device, the one or more contexts associated with the one or more previously identified tokens of the plurality of tokens.

7. The method of claim 1, wherein M is equal or less than a predetermined number.

8. The method of claim 1, wherein for an iteration that is subsequent to the individual iteration of the plurality of iterations:
N is incremented by one, and
M remains unchanged.

9. The method of claim 1, wherein the plurality of M contexts are associated with:
a first subset of one or more most recently identified tokens; and
a second subset of tokens, wherein the second subset of tokens is separated from the first subset of tokens by one or more tokens unrepresented in the plurality of M contexts.

10. A system comprising:
one or more processing units to:
perform a plurality of iterations of a neural network decoder, wherein an individual iteration of the plurality of iterations comprises a context stage and a token generation stage, wherein to perform the context stage of the individual iteration, the one or more processing units are to:
determine a context associated with a current token of a plurality of tokens; and
identify, using a plurality of M contexts, a current hidden state, wherein the plurality of M contexts comprises:
the context associated with the current token, and
one or more contexts associated with corresponding one or more previously identified tokens of the plurality of tokens; and
wherein to perform the token generation stage of the individual iteration, the one or more processing units are to:
identify, using a plurality of N hidden states, a next token of the plurality of tokens, wherein the plurality N hidden states comprises:
the current hidden state, and
one or more hidden states identified during corresponding one or more previous iterations of the plurality of iterations, wherein N is greater than M.

11. The system of claim 10, wherein to identify the current hidden state, the one or more processing units are to:
compute a weighted combination of a plurality of M values, wherein an individual context of the plurality of M contexts comprises a respective value of the plurality of M values.

12. The system of claim 11, wherein the respective value of the plurality of M values is weighted, in the weighted combination of the plurality of M values, using a weight characterizing a degree of similarity of a respective key of a plurality of M keys to a query associated with the current token, wherein the individual context of the plurality of M contexts further comprises the respective key of the plurality of M keys.

13. The system of claim 12, wherein each of (i) an individual value of the plurality of M values and (i) an individual key of the plurality of M keys is obtained based on a corresponding token of the plurality of tokens using one or more parameters learned during training of the neural network decoder.

14. The system of claim 13, wherein an individual token of the plurality of tokens comprises a language unit associated with at least one of:
a word,
a portion of a word,
a combination of two or more words,
a punctuation mark, or
an end of string symbol.

15. The system of claim 10, wherein to perform the context stage of the individual iteration, the one or more processing units are further to:
store, in a memory device, the determined context associated with the current token of a plurality of tokens; and
wherein to identify the current hidden state, the one or more processing units are to:
retrieve, from the memory device, the one or more contexts associated with the one or more previously identified tokens of the plurality of tokens.

16. The system of claim 10, wherein M is equal or less than a predetermined number.

17. The system of claim 10, wherein for an iteration that is subsequent to the individual iteration of the plurality of iterations:
N is incremented by one, and
M remains unchanged.

18. The system of claim 10, wherein the plurality of M contexts are associated with:
a first subset of one or more most recently identified tokens; and
a second subset of tokens, wherein the second subset of tokens is separated from the first subset of tokens by one or more tokens unrepresented in the plurality of M contexts.

19. A system comprising one or more processors to predict, using a set of N hidden states, a token, an individual hidden state of the set of N hidden states generated using an attention-based neural network using M predicted tokens, wherein M is smaller than N.

20. The system of claim 19, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing conversational AI operations;
a system implementing one or more language models;
a system implementing one or more large language models (LLMs);
a system implementing one or more vision language models (VLMs);
a system implementing one or more multi modal language models;
a system for generating synthetic data;
a system incorporating one or more virtual machines (VMs);
a system implemented at least partially in a data center; or
a system implemented at least partially using cloud computing resources.
